(19) United States
(12) Patent Application Publication
(10) Pub. No.: US 2009/0156253 A1
(43) Pub. Date: Jun. 18, 2009

(54) Apparatus and Methods for Providing Fully Qualified Domain Name Resolution for Home Network Realm Based on International Mobile Subscriber Identity

(75) Inventors: Jianxiong Shi, Pleasanton, CA (US); Cherif Jazra, Sunnyvale, CA (US); Qin Zhang, Sunnyvale, CA (US)

Correspondence Address: KACVINSKY LLC;4500 BROOKTREE ROAD, SUITE 102, WEXFORD, PA, 15090, US

(73) Assignee: PALM, INC., Sunnyvale, CA (US)

(21) Appl. No.: 11/958,994

(22) Filed: Dec. 18, 2007

(51) Int. Cl. H04M 1/00

(52) U.S. Cl. 455/558

(57) ABSTRACT

Various embodiments for providing fully qualified domain name (FDQN) resolution for a home network realm based on an International Mobile Subscriber Identity (IMSI) are described. In one embodiment, a mobile computing device may be arranged to retrieve an IMSI including a Mobile Country Code (MCC) and a Mobile Network Code (MNC) and to derive an initial FQDN from the IMSI using an initial MNC rule. The mobile computing device may transmit an initial domain name system (DNS) request comprising the initial FQDN. The mobile computing device may be arranged to derive an alternate FQDN from the IMSI using an alternate MNC rule and to transmit a subsequent DNS request comprising the alternate FQDN when a DNS error message is received in response to the initial DNS request. Other embodiments are described and claimed.

### BACKGROUND

A mobile computing device such as a combination handheld computer and mobile telephone or smart phone generally may provide voice and data communications functionality as well as computing and processing capabilities on various networks. The mobile computing device may be associated with a unique user identity for a mobile subscriber such as an International Mobile Subscriber Identity (IMSI) conforming to International Telecommunication Union (ITU) standards. An IMSI is a unique number having no more than fifteen digits including a three digit mobile country code (MCC) identifying the country or domicile of the mobile subscriber, a two or three digit Mobile Network Code (MNC) identifying the home Public Land Mobile Network (PLMN) of the mobile subscriber, and a mobile station identification number (MSIN) identifying the mobile subscriber within a PLMN.

To access PLMN services from a home PLMN (HPLMN) or a visited PLMN (VPLMN), a mobile computing device may require authentication using an IMSI-based user identity. Network authentication may be performed in accordance with an Extensible Authentication Protocol (EAP) using a Network Access Identifier (NAI) derived from the IMSI. As described in IETF RFC 2486, January 1999: “The Network Access Identifier,” the NAI includes a username and a realm name in the form of an Internet domain name as specified in IETF RFC 1035, January 1999: “Domain Names—Implementation and Specifications.”

To obtain authentication, the mobile computing device may access the IMSI from a Subscriber Identity Module (SIM) or Universal SIM (USIM) on a smart card such as a SIM card or Universal Integrated Circuit Card (UICC) and derive an IMSI-based user identity. For example, when attempting to authenticate within wireless local area network (WLAN) access, the mobile computing device can derive the home network domain name from the IMSI as specified in 3G Partnership Project Technical Specification (3GPP TS) 23.003, March 2005: “Numbering, addressing and identification.” Namely, the first five or six digits of the IMSI are taken, depending on whether a two or three digit MNC is used, and separated into MCC and MNC. For a two digit MNC, a zero is added to the beginning. The MCC and MNC are used to create a “mnc<MNC>.mcc<MCC>.3gppnetwork.org” domain name, and the label “wlan.” is added to the beginning of the domain name. An example of a WLAN NAI realm provided in 3GPP TS 23.003 for IMSI: 234150999999999 where MCC=234, MNC=15, and MSIN=0999999999 is the domain name:

wlan.mnc015.mcc234.3gppnetwork.org.

If a fully qualified domain name (FDQN) constructed for the home network realm is not recognized by a Domain Name System (DNS) device on the network, resolution of the domain name will fail resulting in the mobile computing device being unable to register or acquire services. Because the MNC does not have a fixed length and could be either two digits or three digits, a user may experience problems when attempting authentication using IMSI-based FQDN. Although 3GPP TS 31.102, October 2005: “Characteristic of the Universal Subscriber Identity Module (USIM) Application” defines a field in an elementary file (EF) for Administrative Data (EF_{AD}) called “length of MNC,” older SIMs do not include such a field. Furthermore, even where the length of the MNC is provided in the SIM, inconsistencies in provisioning among mobile computing devices and the MNC codes specified by network carriers may cause the mobile computing device to derive an unresolvable FQDN due to the ambiguities arising from variable MNC length. Accordingly, there exists the need for an apparatus and methods for providing improved IMSI-based FQDN resolution.

### BRIEF DESCRIPTION OF THE DRAWINGS

FIG. 1 illustrates one embodiment of a communications system.

FIG. 2 illustrates one embodiment of a communications system

FIG. 3 illustrates one embodiment of a mobile computing device.

FIG. 4 illustrates one embodiment of a FQDN derivation logic flow.

### DETAILED DESCRIPTION

Various embodiments are directed to providing fully qualified domain name (FDQN) resolution for a home network realm based on an International Mobile Subscriber Identity (IMSI). In one embodiment, a mobile computing device may be arranged to retrieve an IMSI including a Mobile Country Code (MCC) and a Mobile Network Code (MNC) and to derive an initial fully qualified domain name (FQDN) from the IMSI using an initial MNC rule. The mobile computing device may transmit an initial domain name system (DNS) request comprising the initial FQDN. The mobile computing device may be arranged to derive an alternate FQDN from the IMSI using an alternate MNC rule and transmit a subsequent DNS request comprising the alternate FQDN when a DNS error message is received in response to the initial DNS request. The initial MNC rule may comprise a two digit or a three digit MNC rule, for example.

In some implementations, the IMSI is accessed from a subscriber identity module (SIM) of the mobile computing device, and the initial MNC rule is determined based on an elementary file in the SIM indicating a length of the MNC. In some implementations, the initial MNC rule is determined based on the MCC of the IMSI. For example, the mobile computing device may identify a home country from the MCC and determine the initial MNC rule depending on whether the home country is a North American country.

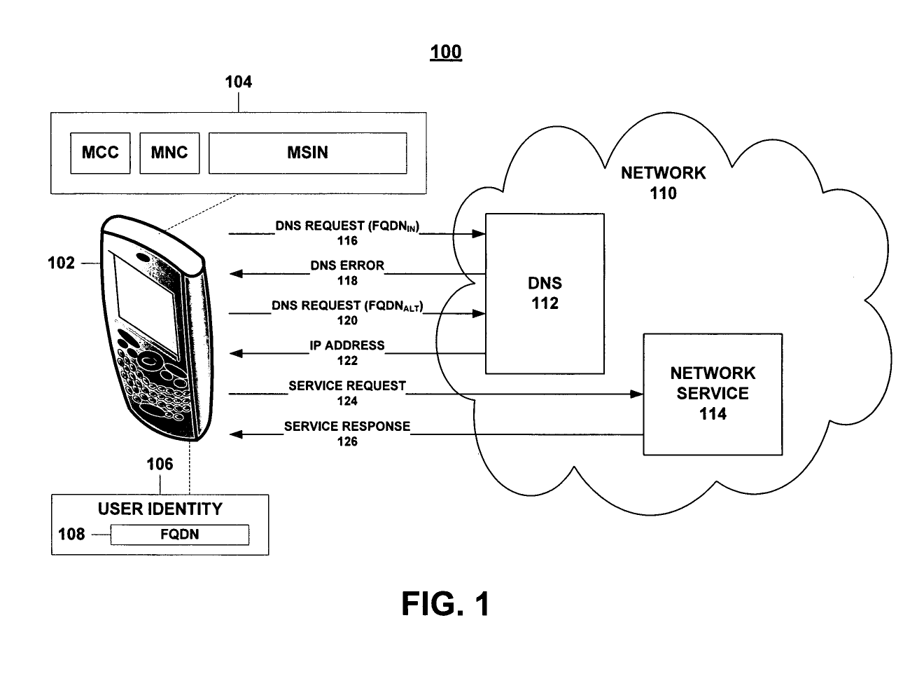

FIG. 1 illustrates a communications system 100 suitable for implementing various embodiments. Elements of the communications system 100 may comprise physical or logical entities for communicating information and may be implemented as hardware, software, or combination thereof, as desired for a given set of design parameters or performance constraints. Although FIG. 1 includes a limited number of elements for purposes of illustration, it can be appreciated that the communications system 100 may include more or less elements as well as other types of elements. While some embodiments and examples may be described in the context of a certain type of communication, it can be appreciated that the principles and techniques may be implemented for any type of communication in accordance with the described embodiments.

As shown, the communications system 100 may comprise a mobile computing device 102. The mobile computing device 102 may comprise or be implemented as a combination handheld computer and mobile telephone or smart phone such as a Palm® Treo™ smart phone. Although some embodiments may be described with the mobile computing device 102 implemented as a smart phone by way of example, it may be appreciated that the mobile computing device 102 may be implemented as other types of user equipment (UE) or wireless computing devices having voice and/or data communications functionality such as a handheld device, personal digital assistant (PDA), mobile telephone, combination mobile telephone/PDA, mobile unit, subscriber station, game device, messaging device, media player, pager, or any other suitable communications device in accordance with the described embodiments.

The mobile computing device 102 may comprise a housing encapsulating various internal components such as a printed circuit board (PCB), internal antennas, a removable and rechargeable battery, as well as one or more processors (e.g., host processor, radio processor, modem processor, baseband processor), memory (e.g., volatile or non-volatile memory, removable or non-removable memory, erasable or non-erasable memory, writeable or re-writeable memory), transceivers (e.g., voice communications transceiver, data communications transceiver, GPS transceiver), and others. The mobile computing device 102 also may comprise various input/output (I/O) devices such as a keyboard, keys, buttons, switches, a microphone, speakers, an audio headset, a camera, a touch-sensitive display screen, a stylus, and so forth.

The mobile computing device 102 may be arranged to provide voice and data communications in accordance with one or more cellular telephone networks or systems. Examples of cellular telephone networks or systems may include Code Division Multiple Access (CDMA), Global System for Mobile Communications (GSM), North American Digital Cellular (NADC), Time Division Multiple Access (TDMA), Extended-TDMA (E-TDMA), Narrowband Advanced Mobile Phone Service (NAMPS), third generation (3G) networks or systems such as Wide-band CDMA (WCDMA), CDMA-2000, Universal Mobile Telephone System (UMTS), and others.

In addition to voice communications functionality, the mobile computing device 102 may provide wireless wide area network (WWAN) data communications functionality including Internet access in accordance with one or more cellular telephone networks or systems. Examples of cellular telephone networks or systems offering WWAN data communications services may include Evolution-Data Optimized or Evolution-Data only (EV-DO), Evolution For Data and Voice (EV-DV), CDMA/1xRTT, GSM with General Packet Radio Service systems (GSM/GPRS), Enhanced Data Rates for Global Evolution (EDGE), High Speed Downlink Packet Access (HSDPA), High Speed Uplink Packet Access (HSUPA), and others.

The mobile computing device 102 also may be arranged to provide data communications functionality in accordance with various types of wireless local area network (WLAN) systems. Examples of suitable WLAN systems offering data communications services may include the Institute of Electrical and Electronics Engineers (IEEE) 802.xx series of protocols, such as the IEEE 802.11a/b/g/n series of standard protocols and variants (also referred to as “WiFi”), the IEEE 802.16 series of standard protocols and variants (also referred to as “WiMAX”), the IEEE 802.20 series of standard protocols and variants, and others.

The mobile computing device 102 may be arranged to perform data communications functionality in accordance with various types of shorter range wireless networks or systems, such as a wireless personal area network (PAN) offering Bluetooth® data communications services in accordance with the Bluetooth® Special Interest Group (SIG) series of protocols, specifications, profiles, and so forth. Other examples of shorter range wireless networks or systems may employ infrared (IR) techniques or near-field communication techniques and protocols, such as electro-magnetic induction (EMI) techniques. Exemplary EMI techniques may include passive or active radio-frequency identification (RFID) protocols and devices.

The mobile computing device 102 may comprise an antenna system including one or more internal and/or external antennas tuned for operating at one or more frequency bands. This may be desirable since the mobile computing device 102 may be compatible with multiple wireless data, multimedia, and/or cellular telephone networks or systems. In some cases, the mobile computing device 102 may be implemented as a multi-band wireless device supporting operation in multiple frequency bands. For example, the mobile computing device 102 may be arranged to operate in various frequency bands or sub-bands such as the 2.4 GHz range of the ISM frequency band for WiFi and Bluetooth® communications, one or more of the 850 MHz, 900 MHZ, 1800 MHz, and 1900 MHz frequency bands for GSM, CDMA, TDMA, NAMPS, cellular, and/or PCS communications, the 2100 MHz frequency band for CDMA2000/EV-DO and/or WCDMA/UMTS communications, the 1575 MHz frequency band for Global Positioning System (GPS) operations, and other frequency bands.

The mobile computing device 102 may comprise one or more transceivers arranged to communicate using different types of protocols, communication ranges, operating power requirements, RF sub-bands, information types (e.g., voice or data), use scenarios, applications, and so forth. The mobile computing device 102 may comprise, for example, one or more cellular transceivers or components arranged to support communication over a cellular voice channel for a network such as CDMA, GSM, and/or UMTS. The mobile computing device 102 also may comprise one or more WWAN transceivers or components arranged to support data communication over a WWAN data channel in accordance with one or more WWAN protocols such as EVDO protocols, EVDV protocols, CDMA/1xRTT protocols, GSM/GPRS protocols, EDGE protocols, HSDPA protocols, and so forth. The mobile computing device 102 may comprise one or more transceivers or components arranged to support data communication over a WLAN data channel in accordance with one or more WLAN protocols such as IEEE 802.11a/b/g/n protocols, IEEE 802.16 protocols, IEEE 802.20 protocols, PAN protocols, Infrared protocols, Bluetooth® protocols, EMI protocols including passive or active RFID protocols, and so forth. The mobile computing device 102 also may comprise a GPS transceiver to support position determination capabilities and/or location-based services (LBS).

The mobile computing device 102 may be associated with an IMSI 104 conforming to ITU standards. The IMSI 104 comprises a unique number having no more than fifteen digits including a three digit MCC identifying the country or domicile of the mobile subscriber, a two or three digit MNC identifying the home network of the mobile subscriber, and an MSIN identifying the mobile subscriber within a network. In various embodiments, the IMSI 104 may be accessed from a SIM or USIM on a smart card such as a SIM card or UICC of the mobile computing device 102.

The mobile computing device 102 may be arranged to generate an IMSI-based user identity 106 comprising a FQDN 108 derived from the IMSI 104. The mobile computing device 102 may provide the user identity 106 to a network 110 for authentication and access to various voice and data communications services. Exemplary services provided by the network 110 may include telephony services, messaging services such as short message service (SMS), multimedia messaging service (MMS), and Instant Messaging (IM), Internet services, WLAN services, Voice-over-IP (VoIP) services, multimedia services, gaming services, LBS services, and other voice and/or data services.

The network 110 generally may comprise or be implemented by any type of network that supports voice and data communications services in accordance with the described embodiments. For example, the network 110 may comprise a Public Land Mobile Network (PLMN) supporting both circuit switched (CS) and packet switched (PS) services. The network 110 may comprise a GSM PLMN supporting voice and data communications services such as GSM, GPRS, and EDGE. The network 110 also may comprise a UMTS PLMN supporting voice and data communication such as UMTS, WCDMA, HSDPA, and HSUPA. In various embodiments, the network 110 may support unlicensed mobile access (UMA) to voice and data communications services. The network 110 also may support interworking WLAN (I-WLAN) access to voice and data communications services as well as direct IP access to the Internet and/or an Intranet.

The network 110 may support various IP Multimedia Subsystem (IMS) services. Exemplary IMS services may include Session Initiation Protocol (SIP)-based services such as such as VoIP, video telephony, multimedia conferencing, multiplayer and/or multipart gaming, push-to-talk (PTT), push-to-video, Text-to-Speech (TTS), IM, content sharing, and other multimedia services.

The network 110 may support LBS such as wireless 911 emergency services, roadside assistance, asset tracking, fleet management, friends and family locator services, dating services, and navigation services which may provide the user with maps, directions, routing, traffic updates, mass transit schedules, information regarding local points-of-interest (POI) such as restaurants, hotels, landmarks, and entertainment venues, and other types of LBS services in accordance with the described embodiments. In various embodiments, LBS may be supported by the network 110 in accordance with a Secure User Plane Location (SUPL) location platform (SLP) comprising a SUPL Positioning Center (SPC) and SUPL Location Center (SLC).

The mobile computing device 102 may provide the user identity 106 comprising the FQDN 108 derived from the IMSI 104 to the network 110 for authentication and access to various voice and data communications services. The network 110 may comprise a Domain Name System (DNS) node 112 and a network services node 114. The DNS node 112 may be arranged to perform domain name resolution of the FQDN 108 by translating the domain name into an IP address which may be used by the mobile computing device to connect to the network services node 114. The network services node 114 may be arranged to provide various types of voice and data communications services to the mobile computing device 102 in accordance with the described embodiments.

In various implementations, the FQDN 108 of the IMSI-based user identity 106 may represent the home network realm of the mobile computing device 102. For example, the IMSI-based user identity 106 may be implemented using a Network Access Identifier (NAI) format in accordance with IETF RFC 2486 and IETF RFC 1035. To represent the home network realm, the FQDN 108 may comprise an MNC portion such as “mnc<MNC>.” and an MCC portion such as “mcc<MCC>.” where <MNC> and <MCC> are each three digit numbers. The FQDN 108 also may comprise a top level domain such as “3gppnetwork.org” following the MNC and MCC portions. The FQDN 108 may further comprise a label preceding the MNC and MCC portions such as, for example, the label “wlan” in the context of I-WLAN services, the label “ims” in the context of IMS-based services, and the label “h-slp” in the context of SUPL-based location services. It is to be appreciated that the principles and techniques described herein may be implemented for any type of IMSI-based FQDN 108 having various top level domains and/or labels in accordance with the described embodiments.

The mobile computing device 102 may be arranged to derive the FDQN 108 by selecting among MNC rules. In various embodiments, the MNC rules for deriving the FQDN 108 may comprise a two digit MNC rule and a three digit MNC rule.

Referring to the example of 3GPP TS 23.003 for IMSI 234150999999999, if a two digit MNC rule is used by the mobile computing device 102 to derive the FQDN 108, the first five digits may be taken and separated into MCC=234 and MNC=15. A leading zero is then added to the two digit MNC resulting in a three digit MNC=015. In this example, the FQDN 108 would comprise an MNC portion “mnc015.” and an MCC portion “mcc234.” In the context of I-WLAN services, the FQDN 108 may comprise the top level domain “3gppnetwork.org” following the MNC and MCC portions, and the label “wlan” preceding the MNC and MCC portions. Accordingly, the FQDN 108 “wlan.mnc015.mcc234.3gppnetwork.org” would be derived according to the two digit MNC rule.

If, however, a three digit MNC rule is used by the mobile computing device 102 to derive the FQDN 108 from the IMSI: 234150999999999, the first six digits are taken and separated into MCC=234 and MNC=150. In this case, the FQDN 108 would comprise an MNC portion “mnc150.” and an MCC portion “mcc234.” In the context of I-WLAN services, the FQDN 108 may comprise the top level domain “3gppnetwork.org” following the MNC and MCC portions, and the label “wlan” preceding the MNC and MCC portions. Accordingly, the FQDN 108 “wlan.mnc150.mcc234.3gppnetwork.org” would be derived according to the three digit MNC rule.

As shown, the mobile computing device 102 may send an initial DNS request 116 to the DNS node 112 on the network 110. The initial DNS request 116 may comprise an initial FQDN (FQDN_{IN}) derived from the IMSI 104 according to an initial MNC rule. In various embodiments, the initial MNC rule for deriving the FQDN_{IN} may comprise either a two digit or three digit MNC rule.

In some embodiments, the initial MNC rule used to derive the FQDN_{IN} may be based on an elementary file (EF) in the SIM of the mobile computing device 102. For example, the SIM may comprise an Administrative Data EF (EF_{AD}) including a field indicating the length of the MNC. In such embodiments, the mobile computing device 102 may select the initial MNC rule to be either a two digit MNC rule or a three digit MNC rule in accordance with the length of the MNC (e.g., 2 or 3) indicated by the EF_{AD}. It may be appreciated that certain SIMs may not include an EF_{AD}.

In some embodiments, the initial MNC rule used to derive the FQDN_{IN} may be based on the MCC. For example, the MCC of the IMSI 104 may used to determine the home country of the mobile subscriber by mapping the MCC to a particular country. In some cases, the initial MNC rule may be selected to be a two digit MNC rule when the home country is not within North America and selected to be a three digit MNC rule when the home country is in North America. It can be appreciated that a two digit MNC rule may be selected for the initial MNC rule when the home country is in North America in some embodiments.

In response to the initial DNS request 116, the DNS node 112 on the network 110 may attempt to resolve the FQDN_{IN} derived using the initial MNC rule. As shown, the DNS resolution fails in this instance, and the DNS node 112 sends a DNS error 118 to the mobile computing device 102. It can be appreciated that DNS failure may occur for various reasons. For example, the mobile computing device 102 may be arranged to use a three digit MNC rule whereas devices on the network 110 may be provisioned in accordance with a two digit MNC rule. Even if the length of the MNC is indicated by the SIM of the mobile computing device 102, the length might not be the same as the MNC length broadcast or used by the network 110 in a certain region. As such, there can be inconsistencies or unknowns concerning the actual MNC length to be used relative to the mobile computing device 102 and the network 110.

When the mobile computing device 102 receives the DNS error 118, the mobile computing device 102 may recognize that DNS failure has occurred using the FQDN_{IN} and derive an alternate FQDN (FQDN_{ALT}) from the IMSI 104 according to an alternate MNC rule. In general, the alternate MNC rule used to derive the FQDN_{ALT} may be based on the initial MNC rule. In various embodiments, the alternate MNC rule for deriving the FQDN_{ALT} may comprise either a two digit or three digit MNC rule. For example, the alternate MNC rule may be selected to be a two digit MNC rule when the initial MNC rule comprises a three digit MNC rule and selected to be a three digit MNC rule when the initial MNC rule comprises a two digit MNC rule. It can be appreciated that either a two digit MNC rule or a three digit MNC rule may be selected for the initial MNC rule when the home country of the mobile subscriber is in North America.

After deriving the FQDN_{ALT} from the IMSI 104 using the alternate MNC rule, the mobile computing device 102 may send a subsequent DNS request 120 comprising the FQDN_{ALT} to the DNS node on the network 110. In response to the subsequent DNS request 122, the DNS node 112 on the network 110 may attempt to resolve the FQDN_{ALT} derived using the alternate MNC rule.

As shown, the DNS resolution succeeds in this instance, and the DNS node 112 sends an IP address 112 to the mobile computing device 102. After successful DNS resolution, the mobile computing device 102 may access and/or receive various voice and data services provided by the network 110 by sending a service request 124 to the network service node 114 on the network 110 using the IP address 112 and receiving a service response 126 from the network service node 114.

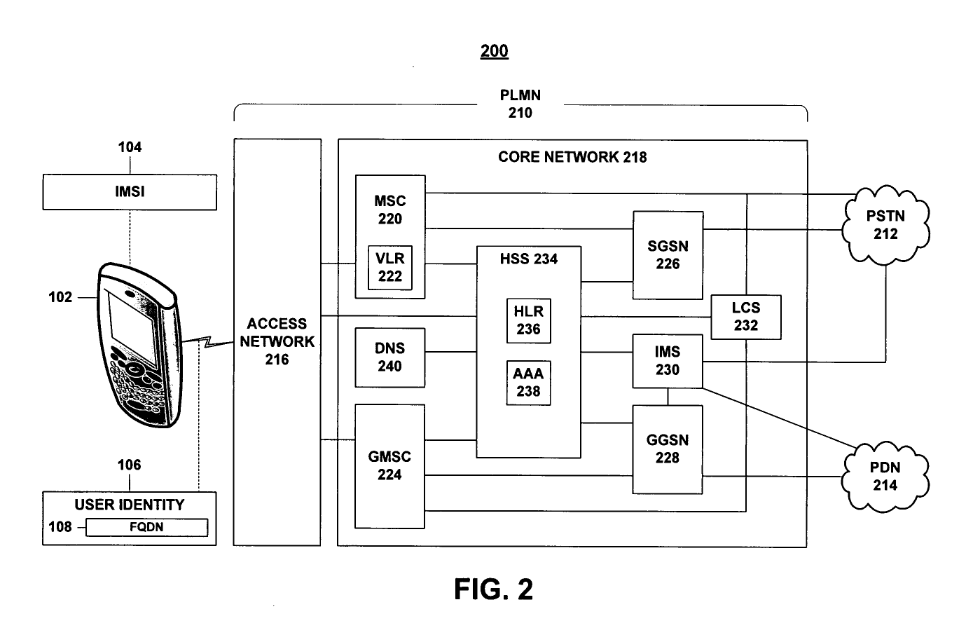

FIG. 2 illustrates a communications system 200 suitable for implementing various embodiments. Elements of the communications system 200 may comprise physical or logical entities for communicating information and may be implemented as hardware, software, or combination thereof, as desired for a given set of design parameters or performance constraints. Although FIG. 2 includes a limited number of elements for purposes of illustration, it can be appreciated that the communications system 200 may include more or less elements as well as other types of elements. While some embodiments and examples may be described in the context of a certain type of communication, it can be appreciated that the principles and techniques may be implemented for any type of communication in accordance with the described embodiments.

As shown, the communications system 200 may comprise a mobile computing device 102. In various embodiments, the mobile computing device 102 may be arranged to retrieve an IMSI 104 and to generate a user identity 106 comprising a FQDN 108 derived from the IMSI 104. The FQDN 108 may comprise an initial FQDN derived using an initial MNC rule or an alternate FQDN derived using an alternate MNC rule as described above. The user identity 106 comprising the FQDN 108 may be used by the mobile computing 102 to request access to and/or receive various voice and data services provided by a Public Land Mobile Network (PLMN) 210.

The PLMN 210 generally may comprise or be implemented by any type of PLMN (e.g., GSM, UMTS, etc.) that supports voice and data communications services in accordance with the described embodiments. The PLMN 210 also may connect to or be interconnected with other networks such as a Public Switched Telephone Network (PSTN) 212, a Public Data Network (PDN) 214 (e.g., Internet, IP network, ISP, etc.) and another PLMNs. It can be appreciated that when roaming, the mobile computing device 102 may access a home PLMN (HPLMN) from a visited PLMN (VPLMN).

The PLMN 210 may comprise an access network 216 and a core network 218. In general, the mobile computing device 102 may communicate with the access network 216 over a wireless link such as an air interface to obtain access to various voice and data services provided by the core network 218. The access network 216 and the core network 218 may comprise or be implemented as any type of network that supports access to and provides voice and data communications services in accordance with the described embodiments. It can be appreciated that the core network 218 may provide various voice and data services through communication with the PSTN 212, the PDN 214, and other PLMNs.

In various embodiments, the access network 216 may comprise a radio access network (RAN) such as a 3G RAN. The access network 216 may comprise a GSM RAN (GRAN) including a base transceiver station (BTS) and a base station controller (BSC) supporting voice and data communications services such as GSM, GPRS, and EDGE. The access network 216 also may comprise a UMTS Terrestrial RAN (UTRAN) including nodes and a radio network controller (RNC) supporting voice and data communication such as UMTS, WCDMA, HSDPA, and HSUPA. The access network 216 also may comprise various components supporting location based services (LBS) such as a location measurement unit (LMU) and a serving mobile location center (SMLC) in communication with a BSC and/or a RNC.

In some embodiments, the access network 216 may comprise an unlicensed mobile access (UMA) network (UMAN) including a UMA network controller (UNC) supporting unlicensed access to voice and data communications services such as GSM, GPRS, and EDGE. In some embodiments, the access network 216 may comprise a WLAN supporting interworking access to voice and data communications services of the core network 218 as well as direct IP access to the Internet and/or an Intranet.

The core network 218 may support both circuit switched (CS) and packet switched (PS) services. The core network 218 may support various CS services using a mobile service switching center (MSC) 220 server having an integrated visitor location register (VLR) 222 and a gateway MSC (GMSC) 224. As shown, the MSC 220 and the GMSC 224 may communicate with the PSTN 212.

The core network 218 may support various PS services using a serving GPRS supporting node (SGSN) 226 and a gateway GPRS supporting node (GGSN) 228 that may communicate within the core network 218 over an inter-PLMN backbone network using a GPRS Tunneling Protocol (GTP). As shown, the GGSN 228 may communicate with the PDN 214. It can be appreciated that the core network 218 also may comprise various gateways for providing access to PS services such as a Border Gateway (BG), Packet Data Gateway (PDG), WLAN access gateway (WAG), IP short message gateway (IP-SM-GW), and others.

The core network 218 may support various multimedia services using an IP Multimedia Subsystem (IMS) 230 in communication with GGSN 228 as well as the PSTN 212, PDN 214, and/or other applications servers. The IMS 230 may comprise various components such as a media resource function (MRF), a call state control function (CSCF), a media gateway control function (MGCF), an IMS media gateway (IM-MGW), and others.

The core network 218 may support LBS using a location services (LCS) server 232. In various embodiments, the LCS server 232 may support various location services by implementing a SLP comprising a SUPL Positioning Center (SPC) and SUPL Location Center (SLC).

The core network 218 may comprise a home subscriber server (HSS) 234 arranged to store profiles or subscription-related information for mobile subscribers and to perform authentication and authorization of mobile subscribers. As shown, the HSS 234 may comprise or implement a Home Location Register (HLR) 234 for storing and managing HLR records containing information (e.g., SIM data) for mobile subscribers authorized to use the core network 218. The HSS 234 also may comprise an Authentication, Authorization, and Accounting (AAA) server 238 for responding to authentication requests and collecting accounting information. It can be appreciated that that the operations performed by the components of the HSS 234 may be combined and/or separated for a given implementation and that the HLR 236 and the AAA server 238 may not be integrated with the HSS 234 in some embodiments.

The MSC 220 and the GMSC 224 may communicate with the HSS 234 when authenticating and authorizing the mobile computing device 102 to access various CS services provided by the PLMN 210 or other networks. The SGSN 226 and the GGSN 228 may communicate with the HSS 132 when authenticating and authorizing the mobile computing device 102 to access various PS services provided by the PLMN 210 or other networks. The HSS 234 also may communicate with the IMS 230 for supporting various IMS-based services and with the LCS server 232 in conjunction with providing location information for mobile subscribers.

As shown, the HSS 234 may communicate with a DNS server 240 arranged to perform domain name resolution by translating between a domain name and an IP address. The DNS server 240 may be arranged to perform DNS resolution in conjunction with the HSS 234 when authenticating and authorizing the mobile computing device 102. It can be appreciated that FIG. 2 illustrates an exemplary implementation of the DNS server 240 and that the DNS server 240 may be implemented in various other ways which are consistent with the described embodiments. For example, in some embodiments, the DNS server 240 may be integrated with the HSS 232 and/or arranged to perform DNS resolution in conjunction with other entities of the core network 218.

In some embodiments, the DNS server 240 may perform DNS resolution of the FQDN 108 in response to a DNS request from the mobile computing device 102. In various implementations, the DNS server 240 may receive an initial DNS request comprising an initial FQDN derived from the IMSI 104 using an initial MNC rule and a subsequent DNS request comprising an alternate FQDN derived from the IMSI 104 using an alternate MNC rule. The DNS server 240 may send a DNS error when resolution fails and may provide an IP address enabling the mobile computing device 102 to access voice and data services provided by the PLMN 210 and/or other networks when resolution succeeds.

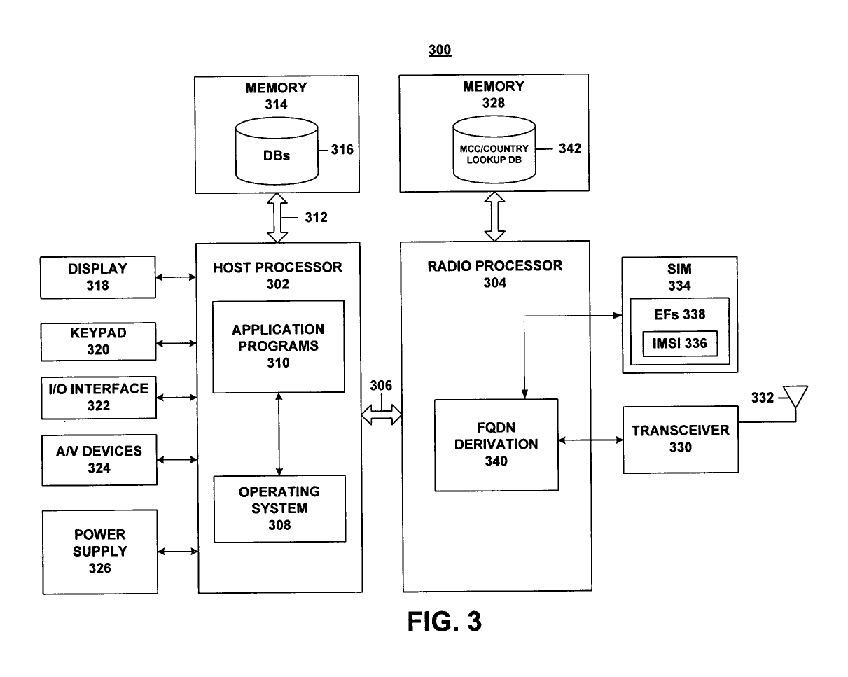

FIG. 3 illustrates a block diagram of a mobile computing device 300 suitable for implementing various embodiments, including the mobile computing device 102. It may be appreciated that the mobile computing device 300 is only one example of a suitable mobile computing environment and is not intended to suggest any limitation as to the scope of use or functionality of the embodiments.

As shown in the embodiment of FIG. 3, the mobile computing device 300 may comprise a dual processor architecture including a host processor 302 and a radio processor 304. In various implementations, the host processor 302 and the radio processor 304 may be arranged to communicate with each other using interfaces 306 such as one or more universal serial bus (USB) interfaces, micro-USB interfaces, universal asynchronous receiver-transmitter (UART) interfaces, general purpose input/output (GPIO) interfaces, control/status lines, control/data lines, audio lines, and so forth. Although the mobile computing device 300 is shown with a dual-processor architecture, it may be appreciated that the mobile computing device 300 may use any suitable processor architecture and/or any suitable number of processors in accordance with the described embodiments. In one embodiment, for example, the processors 302, 304 may be implemented using a single integrated processor.

The host processor 302 may be implemented as a host central processing unit (CPU) using any suitable processor or logic device, such as a as a general purpose processor. The host processor 302 may also be implemented as a chip multiprocessor (CMP), dedicated processor, embedded processor, media processor, input/output (I/O) processor, co-processor, microprocessor, controller, microcontroller, application specific integrated circuit (ASIC), field programmable gate array (FPGA), programmable logic device (PLD), or other processing device in accordance with the described embodiments.

The host processor 302 may be responsible for executing various software programs such as system programs and applications programs to provide computing and processing operations for the mobile computing device 300. For example, the host processor 302 may be responsible for executing various software programs including system programs such as operating system (OS) 308 and application programs 310.

System programs generally may assist in the running of the mobile computing device 300 and may be directly responsible for controlling, integrating, and managing the individual hardware components of the computer system. The OS 308 may be implemented, for example, as a Palm OS®, Palm OS® Cobalt, Microsoft® Windows OS, Microsoft Windows® CE OS, Microsoft Pocket PC OS, Microsoft Mobile OS, Symbian OS™, Embedix OS, Linux OS, Binary Run-time Environment for Wireless (BREW) OS, JavaOS, a Wireless Application Protocol (WAP) OS, or other suitable OS in accordance with the described embodiments. The mobile computing device 300 may comprise other system programs such as device drivers, programming tools, utility programs, software libraries, application programming interfaces (APIs), and so forth.

Application programs 310 generally may allow a user to accomplish one or more specific tasks. In various implementations, the application programs 310 may provide one or more graphical user interfaces (GUIs) to communicate information between the mobile computing device 300 and a user. In some embodiments, application programs 310 may comprise upper layer programs running on top of the OS 308 of the host processor 302 that operate in conjunction with the functions and protocols of lower layers including, for example, a transport layer such as a Transmission Control Protocol (TCP) layer, a network layer such as an Internet Protocol (IP) layer, and a link layer such as a Point-to-Point (PPP) layer used to translate and format data for communication.

Examples of application programs 310 may include, without limitation, messaging applications, web browsing applications, personal information management (PIM) applications (e.g., contacts, calendar, scheduling, tasks), word processing applications, spreadsheet applications, database applications, media applications (e.g., video player, audio player, multimedia player, digital camera, video camera, media management), LBS applications gaming applications, and so forth. Messaging applications may be arranged to communicate various types of messages in a variety of formats. Examples of messaging applications may include without limitation a cellular telephone application, a VoIP application, a PTT application, a voicemail application, a facsimile application, a video teleconferencing application, an IM application, an e-mail application, an SMS application, an MMS application, and so forth. It is also to be appreciated that the mobile computing device 300 may implement other types of applications in accordance with the described embodiments.

As shown, the host processor 302 may be coupled through a memory bus 312 to a memory 314. The memory bus 312 may comprise any suitable interface and/or bus architecture for allowing the host processor 302 to access the memory 314. Although the memory 314 may be shown as being separate from the host processor 302 for purposes of illustration, it is worthy to note that in various embodiments some portion or the entire memory 314 may be included on the same integrated circuit as the host processor 302. Alternatively, some portion or the entire memory 314 may be disposed on an integrated circuit or other medium (e.g., hard disk drive) external to the integrated circuit of the host processor 302. In various embodiments, the mobile computing device 300 may comprise an expansion slot to support a multimedia and/or memory card.

The memory 314 may be implemented using any computer-readable media capable of storing data such as volatile or non-volatile memory, removable or non-removable memory, erasable or non-erasable memory, writeable or re-writeable memory, and so forth. Examples of computer-readable storage media may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information.

The mobile computing device 300 may include various databases 316 implemented in the memory 314. For example, the mobile computing device 300 may include a message content database, a message log database, a contacts database, a media database, a preferences database, and so forth. The message content database may be arranged to store content and attachments (e.g., media objects) for various types of messages sent and received by one or more messaging applications. The message log may be arranged to track various types of messages which are sent and received by one or more messaging applications. The contacts database may be arranged to store contact records for individuals or entities specified by the user of the mobile computing device 300. The media database may be arranged to store various types of media content such as image information, audio information, video information, and/or other data. The preferences database may be arranged to store various settings such as rules and parameters for controlling the operation of the mobile computing device 300.

The mobile computing device 300 may comprise a display 318 coupled to the host processor 302. The display 318 may comprise any suitable visual interface for displaying content to a user of the mobile computing device 300. In one embodiment, for example, the display 318 may be implemented by a liquid crystal display (LCD) such as a touch-sensitive color (e.g., 36-bit color) thin-film transistor (TFT) LCD screen. The touch-sensitive LCD may be used with a stylus and/or a handwriting recognizer program.

The mobile computing device 300 may comprise an alphanumeric keypad 320 coupled to the host processor 302. The keypad 320 may comprise, for example, a QWERTY key layout and an integrated number dial pad. The keypad 320 may comprise a physical keypad using hard buttons, or a virtual keypad using soft buttons displayed on the display 318. The mobile computing device 300 also may comprise various keys, buttons, and switches such as, for example, input keys, preset and programmable hot keys, left and right action buttons, a navigation button such as a multidirectional navigation button, phone/send and power/end buttons, preset and programmable shortcut buttons, a volume rocker switch, a ringer on/off switch having a vibrate mode, and others.

The mobile computing device 300 may comprise an input/output (I/O) interface 322 coupled to the host processor 302. The I/O interface 322 may comprise one or more I/O devices such as a serial connection port, an infrared port, integrated Bluetooth wireless capability, and/or integrated 802.11x (WiFi) wireless capability, to enable wired (e.g., USB cable) and/or wireless connection to a local computer system, such as a local personal computer (PC). In various implementations, mobile computing device 300 may be arranged to synchronize information with a local computer system.

The host processor 302 may be coupled to various audio/video (A/V) devices 324 that support A/V capability of the mobile computing device 300. Examples of A/V devices 324 may include, for example, a microphone, one or more speakers, an audio port to connect an audio headset, an audio coder/decoder (codec), an audio player, a Musical Instrument Digital Interface (MIDI) device, a digital camera, a video camera, a video codec, a video player, and so forth.

The host processor 302 may be coupled to a power supply 326 arranged to supply and manage power to the elements of the mobile computing device 300. In various embodiments, the power supply 326 may be implemented by a rechargeable battery, such as a removable and rechargeable lithium ion battery to provide direct current (DC) power, and/or an alternating current (AC) adapter to draw power from a standard AC main power supply.

The radio processor 304 may be responsible for performing various voice and data communications operations for the mobile computing device 300 such as transmitting and receiving voice and data information over one or more wireless communications channels. The radio processor 304 may be arranged to communicate voice information and/or data information over one or more assigned frequency bands of a wireless communication channel. The radio processor 304 may be implemented as a communications processor using any suitable processor or logic device, such as a modem processor or baseband processor. The radio processor 304 may also be implemented as a digital signal processor (DSP), media access control (MAC) processor, or any other type of communications processor in accordance with the described embodiments. The radio processor 304 may perform analog and/or digital baseband operations for the mobile computing device 300. For example, the radio processor 304 may perform digital-to-analog conversion (DAC), analog-to-digital conversion (ADC), modulation, demodulation, encoding, decoding, encryption, decryption, and so forth.

The mobile computing device 300 may comprise a memory 328 coupled to the radio processor 304. The memory 328 may be implemented using any of the computer-readable media described with reference to the memory 314. The memory 328 may be typically implemented as flash memory and secure digital (SD) RAM. Although the memory 328 may be shown as being separate from the radio processor 304, some or all of the memory 328 may be included on the same IC as the radio processor 304.

The mobile computing device 300 may comprise a transceiver module 330 coupled to the radio processor 304. The transceiver module 330 may comprise one or more transceivers arranged to communicate using different types of protocols, communication ranges, operating power requirements, RF sub-bands, information types (e.g., voice or data), use scenarios, applications, and so forth. In various embodiments, the transceiver module 330 may comprise one or more transceivers arranged to support voice communications and/or data communications for the wireless network systems or protocols as previously described. In some embodiments, the transceiver module 330 may further comprise a Global Positioning System (GPS) transceiver to support position determination and/or location-based services.

The transceiver module 330 generally may be implemented using one or more chips as desired for a given implementation. Although the transceiver module 330 may be shown as being separate from and external to the radio processor 304 for purposes of illustration, it is worthy to note that in various embodiments some portion or the entire transceiver module 330 may be included on the same integrated circuit as the radio processor 304. The embodiments are not limited in this context.

The mobile computing device 300 may comprise an antenna system 332 for transmitting and/or receiving electrical signals. As shown, the antenna system 332 may be coupled to the radio processor 304 through the transceiver module 330. The antenna system 332 may comprise or be implemented as one or more internal antennas and/or external antennas.

The mobile computing device 300 may comprise a subscriber identity module (SIM) 334 coupled to the radio processor 304. The SIM 334 may comprise, for example, a removable or non-removable smart card arranged to encrypt voice and data transmissions and to store user-specific data for allowing a voice or data communications network to identify and authenticate the user. The SIM 334 also may store data such as personal settings specific to the user. In some embodiments, the SIM 334 may be implemented as an UMTS universal SIM (USIM) card, a CDMA removable user identity module (RUIM) card, or a Universal Integrated Circuit Card (UICC). The SIM 334 may comprise a SIM application toolkit (STK) comprising programmed commands for enabling the SIM 334 to perform various functions such as security measures. In some cases, the STK may enable the SIM 334 to independently control various aspects of the mobile computing device 300.

As shown, the SIM 334 may store a unique user identity for a mobile subscriber such as an IMSI 336. The IMSI 336 comprises a unique number having no more than fifteen digits including a three digit MCC identifying the country or domicile of the mobile subscriber, a two or three digit MNC identifying the home network of the mobile subscriber, and an MSIN identifying the mobile subscriber within a network. The SIM 334 also may comprise various elementary files (EFs) 338 storing the communications capability of the mobile computing device 300. In some embodiments, the IMSI may be stored in one of the EFs 338. In various implementations, the EFs 338 may comprise an EF_{AD} including a field identifying the length of the MNC.

As show in FIG. 3, the mobile computing device 300 may comprise or implement a FQDN derivation module 340. In various embodiments, the FQDN derivation module 340 may be implemented by one or more hardware components, software components, and/or combination thereof. For example, the FQDN derivation module 340 may be implemented by FQDN derivation logic (e.g., instructions, data, and/or code) such as software to be executed by a logic device such as the processor 302 of the mobile computing device 300. The FQDN derivation logic may be stored internally or externally to a logic device on one or more types of computer-readable storage media such as memory 310, memory, memory 324, and so forth. In some embodiments, the FQDN derivation logic may be implemented by the SIM 334.

In various embodiments, the FQDN derivation module 340 may be arranged to access the IMSI 336 from the SIM 334 or the EFs 338 of the mobile computing device 300 and derive a FQDN. The FQDN may be implemented by an IMSI-based user identity used for authentication and access to various voice and data communications services.

In various implementations, the FQDN derived by the FQDN derivation module 340 may represent the home network realm of the mobile computing device 102. To represent the home network realm, the FQDN 108 may comprise an MNC portion, an MCC portion, as well as a top level domain following the MNC and MCC portions and a label preceding the MNC and MCC portions.

The FQDN derivation module 340 may be arranged to derive the FDQN by selecting among MNC rules such as a two digit MNC rule and a three digit MNC rule. In various implementations, the FQDN derivation module 340 may derive an initial FQDN from the IMSI 104 according to an initial MNC rule. The initial MNC rule may comprise either a two digit or three digit MNC rule. In some embodiments, the initial MNC rule used to derive the initial FQDN may be based one or more of the EFs 338 such as an EF_{AD} including a field indicating the length of the MNC. In such embodiments, the FQDN derivation module 340 mobile computing device may select the initial MNC rule to be either a two digit MNC rule or a three digit MNC rule in accordance with the length of the MNC (e.g., 2 or 3) indicated by the EF_{AD}. It may be appreciated that SIM 334 may or may not include an EF_{AD}.

In some embodiments, the FQDN derivation module 340 may determine the initial MNC rule based on the MCC of the IMSI 336. For example, the FQDN derivation module 340 may be arranged to identify a home country associated with the user and/or the mobile computing device 300 from the MCC of the IMSI 336 by accessing a lookup database 342 (e.g., MCC-Country lookup database). The lookup database 342 generally may comprise any type of data structure (e.g., array, file, table, record) and may be implemented by various types of storage media (e.g., memory 328). In various embodiments, the lookup database 342 may be arranged to store one or more lookup tables associating particular MCCs with particular countries. The lookup database 342 may be structured to identify a home country from a particular MCC and may indicate whether the home country is a North American country. It can be appreciated that the lookup database 342 may be updated by receiving and/or downloading the most currently available MCC data for the various countries.

In various implementations, after mapping the MCC to a particular country, the FQDN derivation module 340 may select the initial MNC rule to be a two digit MNC rule when the home country is not within North America and select the initial MNC rule to be a three digit MNC rule when the home country is in North America. It can be appreciated that a two digit MNC rule may be selected for the initial MNC rule when the home country is in North America in some embodiments.

The initial FQDN derived by the FQDN derivation module 340 may be included in an initial DNS request and sent to a network device for DNS resolution. In the event of DNS resolution failure, the mobile computing device 300 may receive a DNS error. When the mobile computing device 300 receives the DNS error, the FQDN derivation module 340 may derive an alternate FQDN from the IMSI 336 according to an alternate MNC rule. In general, the alternate MNC rule may be based on the initial MNC rule. In various embodiments, the alternate MNC rule for deriving the alternate FQDN may comprise either a two digit or three digit MNC rule. For example, the alternate MNC rule may be selected to be a two digit MNC rule when the initial MNC rule comprises a three digit MNC rule and selected to be a three digit MNC rule when the initial MNC rule comprises a two digit MNC rule. It can be appreciated that either a two digit MNC rule or a three digit MNC rule may be selected for the initial MNC rule when the home country of the mobile subscriber is in North America.

The alternate FQDN derived from the IMSI 336 by the FQDN derivation module 340 using the alternate MNC rule may be sent to the network in a subsequent DNS request for DNS resolution. If DNS resolution succeeds, the mobile computing device 300 may receive an IP address used to access and/or receive various voice and data services provided by the network.

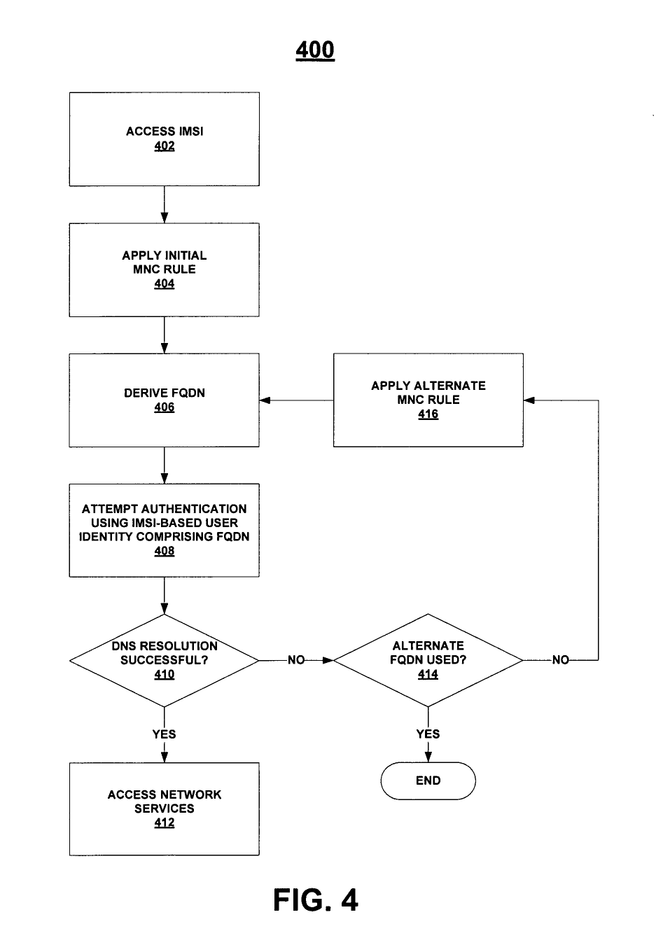

FIG. 4 illustrates a FQDN derivation logic flow 400 in accordance with one or more embodiments. The logic flow 400 may be performed by various systems and/or devices and may be implemented as hardware, software, and/or any combination thereof, as desired for a given set of design parameters or performance constraints. For example, the logic flow 400 may be implemented by a logic device (e.g., processor) and/or logic comprising instructions, data, and/or code to be executed by a logic device.

The logic flow 400 may comprise accessing an IMSI (block 402), applying an initial MNC rule (block 404), deriving a FQDN (block 406), and attempting authentication using an IMSI-based user identity comprising the FQDN (block 408). In various embodiments, the initial MNC rule may comprise either a two digit or three digit MNC rule. In some embodiments, the initial MNC rule used to derive the initial FQDN may be based on the length of the MNC indicated in an EF_{AD}. In some embodiments, the initial MNC rule may be based on the MCC of the IMSI and home country of the mobile subscriber.

If DNS resolution is successful (block 410), network services are accessed (block 412). If DNS resolution is unsuccessful (block 410) and an alternate FQDN has not been used to attempt authentication (block 414), an alternate MNC rule may be applied to the IMSI (block 416). An alternate FQDN may be derived (block 406), and authentication attempted using an IMSI-based user identity comprising the FQDN (block 408). If the authentication attempt fails after using the alternate FQDN (block 414), the process may end.

In various embodiments, the alternate MNC rule may be based on the initial MNC rule and may comprise either a two digit or three digit MNC rule. For example, the alternate MNC rule may be selected to be a two digit MNC rule when the initial MNC rule comprises a three digit MNC rule and selected to be a three digit MNC rule when the initial MNC rule comprises a two digit MNC rule. It can be appreciated that either a two digit MNC rule or a three digit MNC rule may be selected for the initial MNC rule when the home country of the mobile subscriber is in North America.

In various embodiments, logic flow 400 may comprise, or be implemented as, executable computer program instructions. The executable computer program instructions may be implemented by software, a software module, an application, a program, a subroutine, instructions, an instruction set, computing code, words, values, symbols or combination thereof. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The executable computer program instructions may be implemented using any suitable high-level, low-level, object-oriented, visual, compiled and/or interpreted programming language, such as C, C++, Java, BASIC, Perl, Matlab, Pascal, Visual BASIC, assembly language, and others.

In various embodiments, logic flow 400 may comprise, or be implemented as, executable computer program instructions stored in an article of manufacture and/or computer-readable storage medium. The article and/or computer-readable storage medium may store executable computer program instructions that, when executed by a computer, cause the computer to perform methods and/or operations in accordance with the described embodiments. The article and/or computer-readable storage medium may be implemented by various systems and/or devices in accordance with the described embodiments.

The article and/or computer-readable storage medium may comprise one or more types of computer-readable storage media capable of storing data, including volatile memory or, non-volatile memory, removable or non-removable memory, erasable or non-erasable memory, writeable or re-writeable memory, and so forth. Examples of computer-readable storage media may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other suitable type of computer-readable media in accordance with the described embodiments.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

Although some embodiments may be illustrated and described as comprising exemplary functional components or modules performing various operations, it can be appreciated that such components or modules may be implemented by one or more hardware components, software components, and/or combination thereof.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a computer, or any combination thereof.

Some embodiments may be implemented as an article of manufacture comprising a computer-readable storage medium to store executable computer program instructions for performing various operations as described herein. In such embodiments, a computer may include any suitable computer platform, device, system, or the like implemented using any suitable combination of hardware and/or software.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, also may mean that two or more elements are not in direct contact with each other, but yet still co-operate or interact with each other. With respect to software elements, for example, the term “coupled” may refer to interfaces, message interfaces, API, exchanging messages, and so forth.

While certain features of the embodiments have been illustrated as described above, many modifications, substitutions, changes and equivalents will now occur to those skilled in the art. It is therefore to be understood that the appended claims are intended to cover all such modifications and changes as fall within the true spirit of the embodiments.

1. An apparatus comprising:
a mobile computing device to retrieve an International Mobile Subscriber Identity (IMSI) including a Mobile Country Code (MCC) and a Mobile Network Code (MNC), the mobile computing device to derive an initial fully qualified domain name (FQDN) from the IMSI using an initial MNC rule and to transmit an initial domain name system (DNS) request comprising the initial FQDN, the mobile computing device to derive an alternate FQDN from the IMSI using an alternate MNC rule and to transmit a subsequent DNS request comprising the alternate FQDN when a DNS error message is received in response to the initial DNS request.

2. The apparatus of claim 1, the initial MNC rule comprising a two digit MNC rule and the alternate MNC rule comprising a three digit MNC rule.

3. The apparatus of claim 1, the initial MNC rule comprising a three digit MNC rule and the alternate rule comprising a two digit MNC rule.

4. The apparatus of claim 1, wherein the IMSI is accessed from a subscriber identity module (SIM) of the mobile computing device and the initial MNC rule is determined based on an elementary file in the SIM indicating a length of the MNC.

5. The apparatus of claim 1, wherein the initial MNC rule is determined based on the MCC of the IMSI.

6. The apparatus of claim 5, the mobile computing device to identify a home country from the MCC.

7. The apparatus of claim 6, wherein the home country is a North American country and the initial MNC rule comprises a three digit MNC rule.

8. The apparatus of claim 1, wherein each FQDN comprises:
an MNC portion;
an MCC portion;
a top level domain following the MNC portion and the MCC portion; and
a label preceding the MNC portion and the MCC portion.

9. The apparatus of claim 1, wherein each DNS request is communicated to a DNS node on a network.

10. The apparatus of claim 9, the network to support voice and data services comprising one or more of Public Land Mobile Network (PLMN) services, unlicensed mobile access (UMA) services, interworking wireless local area network (I-WLAN) services, Internet Protocol multimedia subsystem (IMS) services, and location based services (LBS).

11. A method comprising:
retrieving an International Mobile Subscriber Identity (IMSI) including a Mobile Country Code (MCC) and a Mobile Network Code (MNC);
deriving an initial fully qualified domain name (FQDN) from the IMSI using an initial MNC rule;
transmitting an initial domain name system (DNS) request comprising the initial FQDN;
receiving a DNS error message in response to the initial DNS request;
deriving an alternate FQDN from the IMSI using an alternate MNC rule; and
transmitting a subsequent DNS request comprising the alternate FQDN.

12. The method of claim 11, the initial MNC rule comprising a two digit MNC rule and the alternate MNC rule comprising a three digit MNC rule.

13. The method of claim 11, the initial MNC rule comprising a three digit MNC rule and the alternate rule comprising a two digit MNC rule.

14. The method of claim 11, further comprising:
accessing the IMSI from a subscriber identity module (SIM); and
determining the initial MNC rule based on an elementary file in the SIM indicating a length of the MNC.

15. The method of claim 11, further comprising determining the initial MNC rule based on the MCC of the IMSI.

16. A computer-readable storage medium comprising executable computer program instructions that if executed enable a computing system to:
retrieve an International Mobile Subscriber Identity (IMSI) including a Mobile Country Code (MCC) and a Mobile Network Code (MNC);
derive an initial fully qualified domain name (FQDN) from the IMSI using an initial MNC rule;
transmit an initial domain name system (DNS) request comprising the initial FQDN;
receive a DNS error message in response to the initial DNS request;
derive an alternate FQDN from the IMSI using an alternate MNC rule; and
transmit a subsequent DNS request comprising the alternate FQDN.

17. The computer-readable storage medium of claim 16, the initial MNC rule comprising a two digit MNC rule and the alternate MNC rule comprising a three digit MNC rule.

18. The computer-readable storage medium of claim 16, the initial MNC rule comprising a three digit MNC rule and the alternate rule comprising a two digit MNC rule.

19. The computer-readable storage medium of claim 16, further comprising executable computer program instructions that if executed enable a computing system to:
access a subscriber identity module (SIM); and
determine the initial MNC rule based on an elementary file in the SIM indicating a length of the MNC.

20. The computer-readable storage medium of claim 16, further comprising executable computer program instructions that if executed enable a computing system to determine the initial MNC rule based on the MCC of the IMSI.
